(19) United States
(12) Patent Application Publication
(10) Pub. No.: US 2011/0029106 A1
(43) Pub. Date: Feb. 3, 2011

(54) METHOD AND ARRANGEMENT IN A MOBILE TERMINAL

(75) Inventors: Peter Claes ISBERG, Lund (SE); Dag GLEBE, Sodra Sandby (SE); Georg SIOTIS, Lund (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/512,555

(22) Filed: Jul. 30, 2009

(51) Int. Cl. G06F 17/00

(52) U.S. Cl. 700/94

(57) ABSTRACT

A method in a mobile terminal, for rendering audio content of a media file, is provided, in which the mobile terminal includes a vibrator for generating vibrations at a particular frequency, based on a voltage applied to the vibrator. The method includes reading the audio content of the media file, identifying signals representing bass tones of the audio content, recognizing the frequency of the bass tones, checking if the frequency is within an operating range of the vibrator; if so, calculating a particular voltage to apply to the vibrator, and applying the calculated voltage to the vibrator, and providing feedback of the vibrator generated frequency, to aid the calculating unit in adjusting the applied voltage for causing the vibrator to generate vibrations at the recognized frequency when the identified bass tones of the media file are rendered.

### TECHNICAL FIELD

The present invention generally relates to a method, an arrangement and a computer program product in a mobile terminal and, more particularly, to a mechanism for improving the acoustic performance of a mobile terminal.

### BACKGROUND OF THE INVENTION

Mobile terminals, such as cordless and cellular telephones, pagers, wireless modems, wireless email devices, personal digital assistants (PDAs), MP3 players and other portable electronic devices are becoming increasingly commonplace. Some of these mobile terminals may be configured to communicate with other devices over a wireless communications network. Users of these mobile terminals typically take these devices with them anywhere they go, which allows these users to, for example, place phone calls, listen to music, watch a movie, access the Internet and the information available thereon using the portable electronic device.

However, when the user desires to listen to audio data such as music from his/her mobile terminal, a problem appear. Due to the high user demand on portability and size limitations, the built in loud speaker may not be capable of reproducing sounds, in particular bass sounds in an appealing way. In order to compromise between portability and loud speaker performance, the ability to replay in particular bass tones on the built in loud speaker of the mobile terminal suffers.

A possible solution may be to provide the mobile terminal with bigger and/or more powerful built in loud speakers. However, the portability of the mobile terminal is harmed by such expansion of the mobile terminal size. Further, enhancement of the built in loud speakers is likely to increase the hardware costs involved for production.

Another possible solution may be to attach an external loud speaker to the mobile terminal. Again however, the portability of the mobile terminal is harmed and production costs increased.

Yet a possible solution may be to simply accept bad replay performance of audio data, in particular in the bass register. However, a problem that then may occur is that the user does not properly hear sound emitted from the mobile terminal, such as e.g. a ring signal in case the mobile terminal has communication ability. A consequence may be that the user misses an incoming phone call because he/she does not perceive the ring signal due to the environmental noise level.

Thus there is a need of improving the acoustic performance in a mobile terminal.

In addition, as competition increases among manufacturers of mobile terminals, there is a marketing need for new functions and features.

### SUMMARY

Embodiments of the invention provide a means related to the acoustic performance of a mobile terminal.

According to a first aspect, the object is achieved by a method in a mobile terminal. The method aims at replaying the audio content of a media file. The mobile terminal comprises a vibrator. The vibrator is configured to generate vibrations at a certain frequency within the working range of the vibrator. The frequency is depending on the voltage applied to the vibrator. The method comprises reading the audio content of the media file. Further, the method comprises identifying a signal representing a bass tone within the read media file. Additionally, the method comprises recognizing the frequency of the bass tone corresponding to the identified signal. Furthermore, the method also comprises checking if the recognized frequency is within the working range of the vibrator. In addition, the method further comprises, if the recognized frequency is within the working range of the vibrator, calculating, in a calculating unit, which voltage to apply on the vibrator in order to generate vibrations at the recognized frequency on the vibrator. Further yet, the method additionally comprises applying the calculated voltage on the vibrator in order to bring the vibrator to generate vibrations on the recognized frequency when the identified bass tone of the media file is to be replayed. Still further, the method also in addition comprises providing feedback of the vibrator generated frequency to the calculating unit, in order to support the calculating unit in adjusting the applied voltage for bringing the vibrator to generate vibrations on the recognized frequency when the identified bass tone of the media file is to be replayed.

According to a second aspect, the object is achieved by an arrangement in a mobile terminal for replaying the audio content of a media file. The mobile terminal comprises a vibrator. The vibrator is configured to generate vibrations at a certain frequency within the working range of the vibrator. The frequency is depending on the voltage applied to the vibrator. The arrangement comprises a reading unit. The reading unit is adapted to read the audio content of the media file. Further, the arrangement comprises an identifying unit. The identifying unit is adapted to identify the signal representing a bass tone within the read media file. Also, in further addition, the arrangement comprises a recognizing unit. The recognizing unit is adapted to recognize the frequency of the bass tone corresponding to the identified signal. Further yet, the arrangement also comprises a checking unit. The checking unit is adapted to check if the recognized frequency is within the working range of the vibrator. Additionally, the arrangement further comprises, also, a calculating unit. The calculating unit is adapted to calculate which voltage to apply on the vibrator in order to generate vibrations at the recognized frequency on the vibrator. The arrangement, still further, also comprises a motor controller. The motor controller is adapted to apply the calculated voltage on the vibrator in order to bring the vibrator to generate vibrations on the recognized frequency when the identified bass tone of the media file is to be replayed. Furthermore, the arrangement in addition comprises an accelerometer. The accelerometer is adapted to provide feedback of the vibrator generated frequency to the calculating unit, in order to support the calculating unit in adjusting the applied voltage for bringing the vibrator to generate vibrations on the recognized frequency when the identified bass tone of the media file is to be replayed.

According to a third aspect, the object is achieved by a computer program product in a mobile terminal for assisting in replaying the audio content of a media file. The mobile terminal comprises a vibrator. The vibrator is configured to generate vibrations at a certain frequency within the working range of the vibrator. The frequency is depending on the voltage applied to the vibrator. The computer program product comprises instruction steps for reading the audio content of the media file. Also, the computer program product comprises instruction steps for identifying a signal representing a bass tone within the read media file. In addition, the computer program product also comprises further instruction steps for recognizing the frequency of the bass tone corresponding to the identified signal. Further yet, the computer program product in addition comprises instruction steps for checking if the recognized frequency is within the working range of the vibrator. Also, the computer program product in addition comprises instruction steps for calculating which voltage to apply on the vibrator in order to generate vibrations at the recognized frequency on the vibrator, if the recognized frequency is within the working range of the vibrator. Furthermore, the computer program product comprises instruction steps for applying the calculated voltage on the vibrator in order to bring the vibrator to generate vibrations on the recognized frequency when the identified bass tone of the media file is to be replayed. Additionally, the computer program product also comprises instruction steps for providing feedback of the vibrator generated frequency, in order to further adjust the applied voltage for bringing the vibrator to generate vibrations on the recognized frequency when the identified bass tone of the media file is to be replayed, when the computer program product is loaded into a processor within the mobile terminal.

Thanks to the present solution, by using the in-built vibrator of a mobile terminal, in a function resembling that of a sub woofer, for replaying bass tones of a replayed media file, a mobile terminal with an improved audio replay performance is achieved. The use of the in-built vibrator of a mobile terminal according to the present invention provides a sensoric approach to the mobile terminal, giving an enhanced rhythm experience when replaying music. Thus the mobile terminal according to the present invention may be used for replaying music with enhanced listener experience.

Further, it is possible to eliminate or at least reduce the risk of loosing a telephone call due to unattended telephone signals. Thus an improved mechanism for improving the acoustic performance of a mobile terminal is achieved. Since the vibrator frequency will follow the bass information of the media file, it will be of a variable frequency nature compared to the common used vibrator schemes that use the same frequency; a variable vibrator frequency will be easier to perceive in a noisy environment.

Other objects, advantages and novel features of the invention will become apparent from the following detailed description of the invention.

### BRIEF DESCRIPTION OF THE DRAWINGS

The present invention will now be described more in detail in relation to the enclosed drawings, in which:

FIG. 1a is a schematic block diagram illustrating a mobile terminal;

FIG. 1b is a schematic block diagram illustrating a cross section of a mobile terminal, depicting a vibrator comprised within the mobile terminal;

FIG. 2 is a flow chart depicting a method in a mobile terminal for improving the acoustic performance of a mobile terminal, according to some embodiments;

FIG. 3 is a flow chart depicting a method in a mobile terminal, according to some embodiments; and

FIG. 4 is a block diagram depicting a mobile terminal, according to some embodiments.

### DETAILED DESCRIPTION

The invention is defined as a method, an arrangement and a computer program product in a mobile terminal, which may be put into practice in the embodiments described below. This invention may, however, be embodied in many different forms and should not be construed as limited to the embodiments set forth herein; rather, these embodiments are provided so that this disclosure will be thorough and complete, and will fully convey the scope of the invention to those skilled in the art. It should be understood that there is no intent to limit the present method, arrangement or computer program product to any of the particular forms disclosed, but on the contrary, the present method, arrangement and computer program product are to cover all modifications, equivalents, and alternatives falling within the scope of the invention as defined by the claims.

Still other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

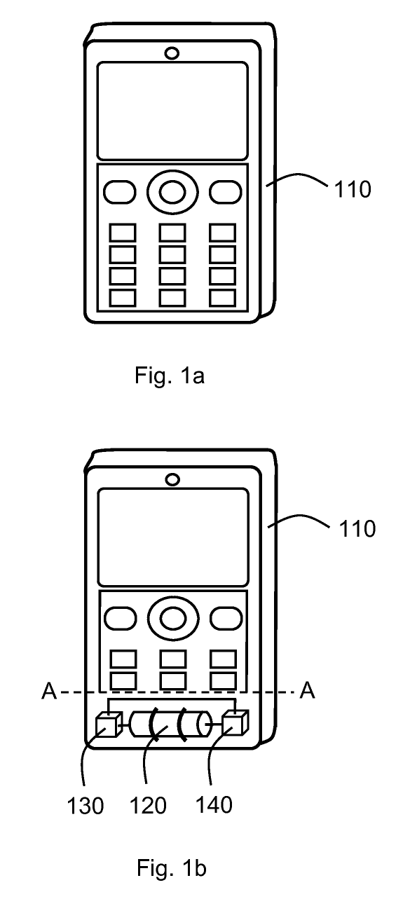

FIG. 1a is a schematic illustration of a mobile terminal 110.

Mobile terminal 110 as herein described may according to some embodiments be represented by a portable communication device such as a mobile station e.g. a mobile cellular telephone. However, as used herein, a “mobile terminal” may include devices having only a wireless signal receiver without transmit abilities and devices having both receive and transmit hardware capable of two-way communication over a two-way communication link as well as devices without any communication ability at all. The mobile terminal 110 may according to some embodiments be a Personal Digital Assistant (PDA), a music player such as e.g. an MP3 player, a radio, a digital audio player, an iPod, a portable media player, a portable multimedia player, a portable video player (PVP), a Compact Disc (CD) player, a laptop, a wireless email device, a digital video camera, a handheld game console, or any other kind of portable electronic device, such as e.g. a notebook computer, a PC speaker, a loud speaker, an avalanche transceiver, a pager, a beeper, a buzzer, an electric bell, a walkie-talkie, a hunting radio, a baby monitor etc.

Mobile terminal 110 may, according to some embodiments, be adapted to communicate within a wireless communication system to a recipient. Mobile terminal 110 may be adapted to communicate e.g. in Code Divisional Multiple Access (CDMA), Wideband Code Division Multiple Access (WCDMA), cdma2000, High Speed Packet Data Access (HSPA), High Speed Downlink Packet Data Access (HSDPA) Fraction High Speed Downlink Packet Data Access (F-HSDPA), High Speed Uplink Packet Data Access (HSUPA), Universal Mobile Telecommunications System (UMTS), Long Term Evolution (LTE), or according to any other wireless or wired communication standard.

FIG. 1b is a schematic illustration of mobile terminal 110 with a cross section A-A over a part of mobile terminal 110, to display a vibrator 120 residing in mobile terminal 110.

Vibrator 120 may be e.g. a cylindrical vibration motor, a coin vibration motor or a shaft less vibration motor according to different embodiments. Vibrator 120 may comprise a rotating eccentric mass, according to some embodiments. Vibration motors present an effective way of generating a high amplitude of oscillating forces within a small physical package, which is an advantage for use within mobile terminal 110.

The vibrator 120 is adapted to provide a vibration function, indicating e.g. an incoming phone call, which may be used in consideration of saving other persons from suffering from noise pollution in places where many people are crowded. The vibrator 120 thus transfers a vibratory force to the casing of the mobile terminal 110, resulting in the unit body of the mobile terminal 110 being vibrated.

Vibrator 120 may be driven at a single direct current (DC) voltage in mobile terminal 110 via a motor controller 130. This voltage is the main factor that determines vibrator's 120 rotational speed, as the relation between applied voltage and rotational speed, or frequency, of vibrator 120 is approximately linear within the operating range of vibrator 120.

Mobile terminal 110 may include an accelerometer 140. Accelerometer 140 is adapted for sensing the frequency of vibrator 120. Thus, accelerometer 140 may measure the frequency of vibrator 120 and forward this information to an analyzing unit such as e.g. a processing unit. The measured frequency of vibrator 120 may be compared with the desired frequency and the drive voltage may be adjusted in order to bring vibrator 120 to produce the desired frequency.

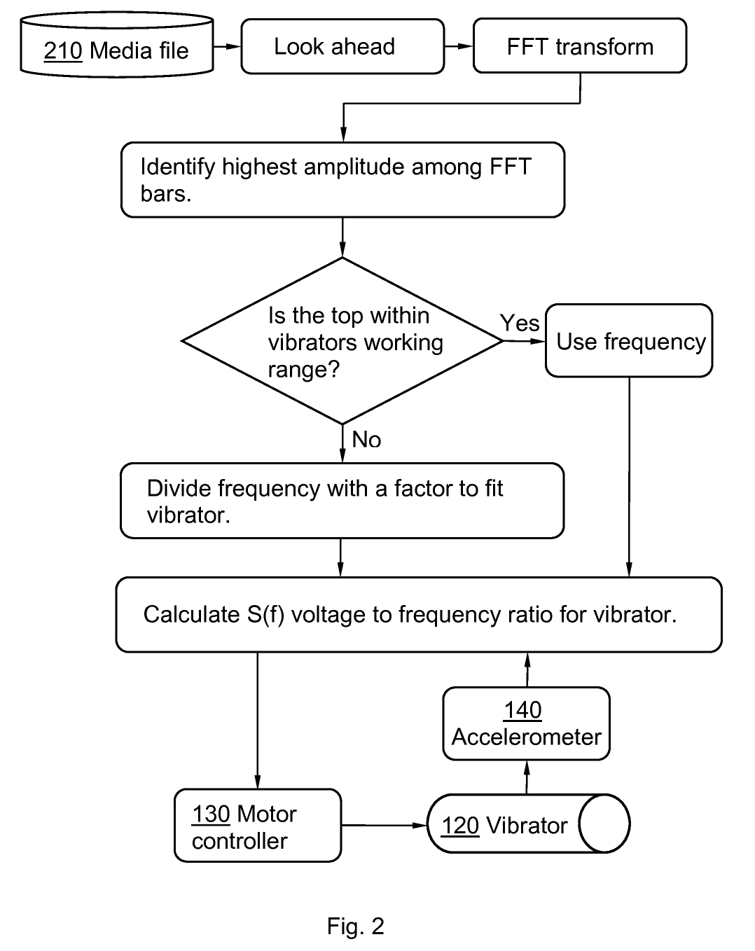

FIG. 2 is a flow chart depicting a method in a mobile terminal 110 for improving the acoustic performance of a mobile terminal 110 comprising a vibrator 120. The present solution aims at using the built-in vibrator 120 in the mobile terminal 110 as a low frequency transducer, or subwoofer. Thus vibrator 120 of mobile terminal 110 may reproduce bass audio frequencies, e.g., from approximately 10 Hz to 150 Hz.

According to one embodiment, mobile terminal vibrator 120 may be used to augment the low frequency performance of conventional loudspeakers of mobile terminal 110.

Further, since much very low bass is felt, sub-bass can be augmented using vibrator 120 as a tactile transducer. Thus, mobile terminal 110 according to the present invention may be attached to the users chair, car seat or home theatre seating, and the vibrations of vibrator may be transmitted to the body then to the ear in a manner similar to bone conduction, according to some embodiments.

An advantage of using mobile terminal vibrator 120 as a tactile transducer used for low frequencies is that it allows a listening environment that is not filled with loud low frequency waves. For home cinema or gaming use, mobile terminal vibrator 120 may help the user avoid disturbing other people, because even powerful sound effects such as explosion sounds in a war videogame or the simulated rumbling of an earthquake in an adventure film may not be heard by others. Thereby an enhanced auditive experience may be achieved, with a minimum of increased auditive pollution.

Thus, according to some embodiments of the present solution, media data such as e.g. an MP3 song may be read, with a certain amount of “look-ahead,” from a media file 210. Media file 210 may be situated within a memory unit comprised within mobile terminal 110, or situated on a media storage device external to mobile terminal 110 and downloaded, according to some embodiments.

The media file 210 may be comprised on any suitable computer usable or computer readable medium. Some arbitrary, non-exhaustive examples of computer readable medium may comprise: an electronic, magnetic, optical, electromagnetic, infrared, or semiconductor system, apparatus, device, or propagation medium, such as e.g. a portable computer diskette, a hard disk, a random access memory (RAM), a read-only memory (ROM), an erasable programmable read-only memory (EPROM) or Flash memory, a compact disc read-only memory (CD-ROM), or transmission media such as those supporting the Internet or an intranet. The media file 210 may further be comprised on paper or another suitable medium upon which the content of the media file 210 may be printed. The content of the media file 210 may be electronically captured, via, for instance, optical scanning of the paper or other medium, then compiled, interpreted, or otherwise processed in a suitable manner, if necessary, and then stored in e.g. a computer memory.

Thus a look-ahead of music file signals is performed. Also, the detected signal may be fast Fourier Transformed (FFT). Using FFT analysis, features of a particular sound spectrum may be visualized e.g. using a spectrogram or providing graphs that illustrate details about the structure of a sound, e.g. the frequencies involved in the generated sound. An intelligent comparator may then find which frequency has the highest amplitude, e.g. by identifying the highest amplitude among the FFT bars in a spectrogram. Thus it may be decided which frequency will be “matched”, or considered to be a bass sound e.g. a bass rhythm within a music melody.

Due to the limitations of the vibrator 120, that may have an optimal operating range between 75 Hz and 150 Hz, in most applications. This can of course vary for different terminal vibrators 120. The match can be either direct if for instance the loudest frequency component lies between 75 Hz and 150 Hz, or scaled by a factor 2, 3, 4 or 5, if for instance the loudest frequency component lies between 150 Hz and 750 Hz, just to mention an arbitrary example.

The optional transfer function may request a frequency from the motor controller 130 that knows what motor voltage will correspond to the wanted frequency, acting like a Voltage Controlled Oscillator (VCO).

According to some embodiments, the relation between supplied voltage and achieved frequency is approximately linear such that:

S(f)=k·f [1]

Where S(f) is the voltage to supply the vibrator 120 with, in order to generate the desired frequency f, while k is a constant.

In an arbitrary example, the vibrator 120 may produce a vibration frequency of 120 Hz when a DC voltage of 2.5 volts is supplied to the vibrator 120. If, at a later time, the supplied voltage of 2.5 volts would produce a different frequency than 120 Hz, such as e.g. 130 Hz, the algorithm [1] and/or the constant k may be updated and adjusted accordingly.

Further, the accelerometer 140 may sense the frequency of the vibrator 120 and provide a feed back functionality. Thereby the achieved frequency of the vibrator 120 may be analyzed and compared with the desired frequency. A signal responsive to the result of the comparison may be generated, in order to adjust drive voltage that is received by the vibrator 120, such that the desired frequency is achieved. Thus the algorithm used in order to compute an adjust drive voltage may be expressed as:

S(f)=k·f+Δ [2]

Where S(f) is the voltage to supply the vibrator 120 with, in order to generate the desired frequency f, while k is a constant and Δ is representing the difference between the achieved frequency and the desired frequency. Thus, Δ<0 if achieved frequency>desired frequency; Δ>0 if achieved frequency<desired frequency and Δ=0 if achieved frequency=desired frequency.

An amount of look ahead inside the mp3 file may be used in order to compensate for the inertia characteristics of the vibrator 120, so the vibrator 120 is synchronized with the bass information in the replayed media file.

An advantage of the present solution is that the mobile terminal 110 with enhanced acoustic performance may be produced without extensive addition of further hardware. Thereby, by a more effective use of existing hardware elements comprised within the mobile terminal 110, production costs, energy consumption and environmental pollution may be kept at a moderate level, which may save resources and costs involved.

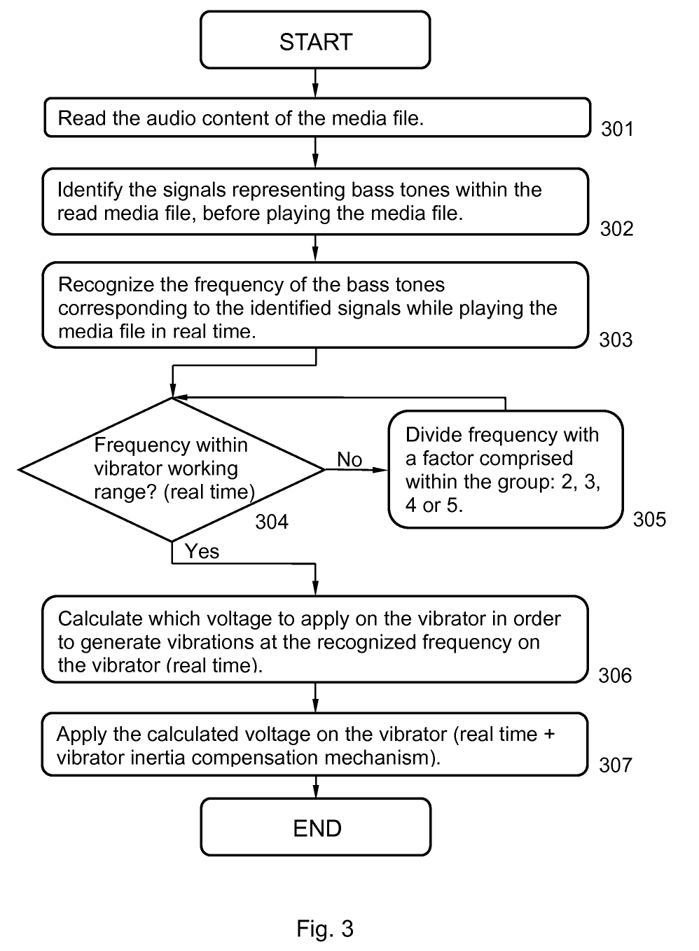

FIG. 3 is a flow chart illustrating embodiments of method steps 301-308 in a mobile terminal 120. The method aims at replaying the audio content of a media file 210. The mobile terminal 110 comprises a vibrator 120. The vibrator 120 is configured to generate vibrations at a certain frequency within the working range of the vibrator 120. The frequency is depending on the voltage applied to the vibrator 120.

To appropriately replay the audio content of the media file 210, the method may comprise a number of steps 301-308. It is however to be noted that some of the described method steps, such as e.g. step 305, are optional and only comprised within some embodiments. Further, it is to be noted that the method steps 301-308 may be performed in any arbitrary chronological order and that some of them, e.g. step 301 and step 302, or even all steps may be performed simultaneously or in an altered, arbitrarily rearranged, decomposed or even completely reversed chronological order. The method may comprise the following steps:

Step 301

The audio content of the media file 210 is read.

Step 302

The signal representing a bass tone is identified within the read media file 210.

Step 303

The frequency of the bass tone, at a given time value, corresponding to the identified signal is recognized.

Step 304

It is checked if the recognized frequency is within the working range of the vibrator 120.

Step 305

The recognized frequency of the bass tone corresponding to the identified signal may be divided with a factor comprised within the group: 2, 3, 4 or 5.

According to some embodiments, the recognized frequency may be divided with 2 or 4, in order to transpose at the octave and replay the same tone but in a lower octave. Such division may optionally be performed repeatedly until the resulting frequency is within the working range of the vibrator 120, according to some embodiments.

Step 306

If the recognized frequency is within the working range of the vibrator 120, it is calculated in a calculating unit 460, which voltage to apply on the vibrator 120 in order to generate vibrations at the recognized frequency on the vibrator 120.

Step 307

The calculated voltage is applied to the vibrator 120 in order to bring the vibrator 120 to generate vibrations on the recognized frequency when the identified bass tone of the media file 210 is to be replayed.

The calculated voltage is to be applied to the vibrator 120 with a vibrator inertia compensation mechanism activated, according to some embodiments.

Step 308

Feedback of the vibrator generated frequency is provided to the calculating unit 460, in order to adjust the applied voltage for bringing the vibrator 120 to generate vibrations on the recognized frequency when the identified bass tone of the media file 210 is to be replayed.

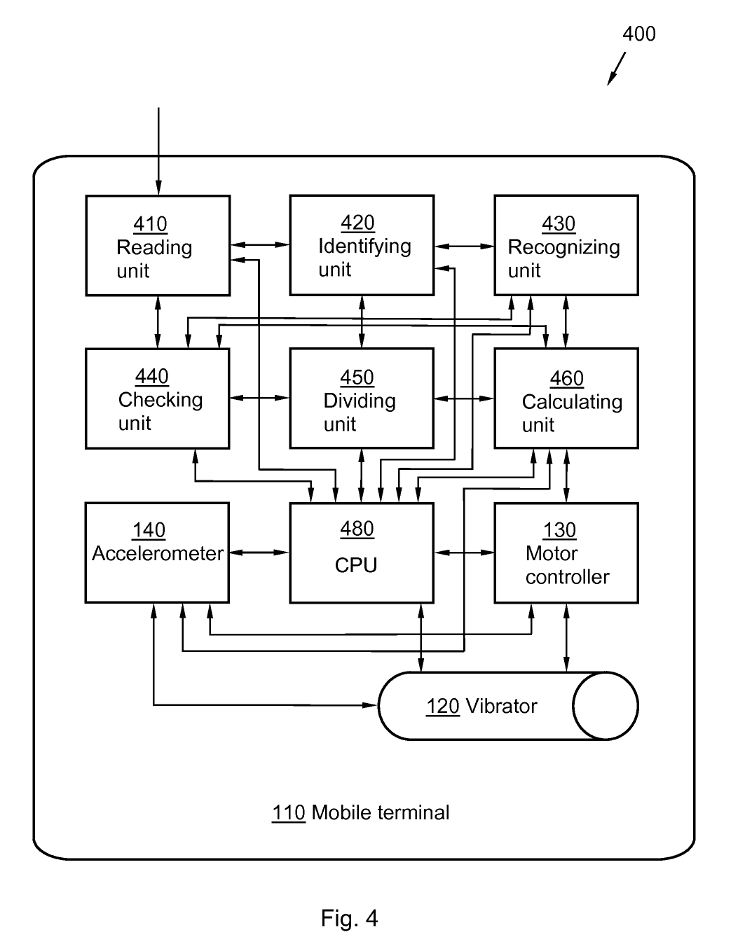

FIG. 4 illustrates an arrangement 400 a mobile terminal 110. Arrangement 400 may be adapted to perform one or more of method steps 301-308 in the mobile terminal 120, for replaying the audio content of a media file 210. The mobile terminal 110 comprises a vibrator 120. The vibrator 120 is configured to generate vibrations at a certain frequency within the working range of the vibrator 120. The frequency is depending on the voltage applied to the vibrator 120.

For the sake of clarity, any internal electronics of the mobile terminal 110, not completely essential for understanding the present solution has been omitted from FIG. 4.

The arrangement 400 comprises a reading unit 410. The reading unit 410 is adapted to read the audio content of the media file 210.

Further, the arrangement 400 comprises an identifying unit 420. The identifying unit 420 is adapted to identify a signal representing a bass tone within the read media file 210.

Also, in addition, the arrangement 400 comprises a recognizing unit 430. The recognizing unit 430 is adapted to recognize the frequency of the bass tone corresponding to the identified signal.

Further yet, the arrangement 400 comprises a checking unit 440. The checking unit 440 is adapted to check if the recognized frequency is within the working range of the vibrator 120.

Still further, the arrangement 400 additionally comprises a calculating unit 460. The calculating unit 460 is adapted to calculate which voltage to apply on the vibrator 120 in order to generate vibrations at the recognized frequency on the vibrator 120.

Moreover, in addition the arrangement 400 further comprises, also, a motor controller 130. The motor controller 130 is adapted to apply the calculated voltage on the vibrator 120 in order to bring the vibrator 120 to generate vibrations on the recognized frequency when the identified bass tone of the media file 210 is to be replayed.

The arrangement 400 furthermore, in addition also comprises an accelerometer 140. The accelerometer 140 is adapted to provide feedback of the vibrator generated frequency to the calculating unit 460, in order to support the calculating unit 460 in adjusting the applied voltage for bringing the vibrator 120 to generate vibrations on the recognized frequency when the identified bass tone of the media file 210 is to be replayed.

In optional further addition, the arrangement 400 according to some embodiments may also comprise a dividing unit 450. The dividing unit 450 is adapted to divide the recognized frequency of the bass tone corresponding to the identified signal with a factor comprised within the group: 2, 3, 4 or 5.

Further, the arrangement 400 may, according to some embodiments, further comprise a processing unit 480. The processing unit 480 may be represented by e.g. a Central Processing Unit (CPU), a processor, a microprocessor, or other processing logic that may interpret and execute instructions. The processing unit 480 may perform data processing functions for inputting, outputting, and processing of data including data buffering and device control functions, such as call processing control, user interface control, or the like.

The processing unit 480 may further be connected to a memory unit. The memory unit may be a primary storage memory unit such as a processor register, a cache memory, a Random Access Memory (RAM) or similar. The memory unit may however in some embodiments be a secondary memory unit such as a Read Only Memory (ROM), Electrically Erasable Programmable Read-Only Memory (EEPROM), programmable read-only memory (PROM) or erasable programmable read-only memory (EPROM) or a hard disk drive. The memory unit may however in some embodiments be an off-line storage memory unit, a flash memory, a USB memory or a memory card. The memory unit may in some embodiments be a Network-attached storage (NAS) or in fact any other appropriate medium such as a disk or a tape that can hold machine readable data.

It is to be noted that the described units 120-480 comprised within the arrangement 400 in the mobile terminal 110 may be regarded as separate logical entities, but not with necessity as separate physical entities. Any, some or all of the units 120-480 may be comprised or co-arranged within the same physical unit. However, in order to facilitate the understanding of the functionality of the arrangement 400, the comprised units 120-480 are illustrated as separate units in FIG. 4.

Computer Program Products

The present method in a mobile terminal 120 for replaying the audio content of a media file 210, according to the method steps 301-308 may be implemented through one or more processors 480 in the mobile terminal 110 together with computer program code for performing the functions of the methods. The program code mentioned above may also be provided as a computer program product, for instance in the form of a data carrier carrying computer program code for performing the methods according to the present solution when being loaded into the processor unit 480. The data carrier may be a CD ROM disc, a memory stick, or any other appropriate medium such as a disk or tape that can hold machine readable data. The computer program code may furthermore be provided as program code on a server and downloaded to the mobile terminal 110 remotely.

Thus a computer program comprising instruction sets for performing the method according to steps 301-308 may be used for implementing the previously described methods. Thereby is provided a computer program product in a mobile terminal 110, for assisting in replaying the audio content of a media file 210. The mobile terminal 110 comprises a vibrator 120. The vibrator 120 is configured to generate vibrations at a certain frequency within the working range of the vibrator 120. The frequency is depending on the voltage applied to the vibrator 120. The computer program product comprises instruction steps for reading the audio content of the media file 210. Also, the computer program product comprises instruction steps for identifying a signal representing a bass tone within the read media file 210. Furthermore, the computer program product comprises instruction steps for recognizing the frequency of the bass tone corresponding to the identified signal. In further addition, the computer program product comprises instruction steps for checking if the recognized frequency is within the working range of the vibrator 120. Also, the computer program product additionally comprises instruction steps for calculating which voltage to apply on the vibrator 120 in order to generate vibrations at the recognized frequency on vibrator 120. Besides, in addition, the computer program product may include further instruction steps for applying the calculated voltage on vibrator 120 to cause vibrator 120 to generate vibrations on the recognized frequency when the identified bass tone of media file 210 is to be rendered. Further yet, the computer program product may include instruction steps for providing feedback of the vibrator generated frequency, in order to further adjust the applied voltage for bringing vibrator 120 to generate vibrations on the recognized frequency when the identified bass tone of media file 210 is to be replayed. The instruction steps are performed when the computer program product is loaded into processor 480 within mobile terminal 110.

The terminology used in the detailed description of the particular exemplary embodiments illustrated in the accompanying drawings is not intended to be limiting of the invention. In the drawings, like numbers refer to like elements.

As used herein, the singular forms “a” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

What is claimed is:

1. A method of rendering audio content of a media file, performed by one or more devices in a mobile terminal including a vibrator, the method comprising:
reading the audio content of the media file;
identifying a signal representing a bass tone within the read audio content of the media file;
determining a frequency range of the bass tone corresponding to the identified signal;
determining whether the determined frequency range is within an operating frequency range of the vibrator;
calculating, by a calculating unit, when the determined frequency range is within the operating frequency range, a particular voltage to apply to the vibrator to generate vibrations within the determined frequency range;
applying the calculated voltage to the vibrator to cause the vibrator to generate vibrations within the determined frequency range when the identified bass tone of the media file is to be rendered; and
providing feedback of the generated vibration to the calculating unit, to allow the calculating unit to adjust the applied voltage to cause the vibrator to maintain vibrations within the determined frequency range when the identified bass tone of the media file is to be rendered.

2. The method of claim 1, where identifying the signal representing a bass tone within the read audio content of the media file comprises:
performing a fast Fourier transformation of the read audio content of the media file, and
recognizing the highest amplitude among the transformed signals.

3. The method of claim 1, further comprising:
dividing the determined frequency range of the bass tone corresponding to the identified signal by a factor comprised one of 2, 3, 4, or 5.

4. The method of claim 3, where the factor is set to 2 and dividing the determined frequency range is performed repeatedly until the frequency is within the operating frequency range of the vibrator.

5. The method of claim 1, where calculating a particular voltage to apply to the vibrator is performed using a voltage-to-frequency transfer function.

6. The method of claim 1, where calculating a particular voltage to apply to the vibrator is performed using a look-up table.

7. An arrangement in a mobile terminal, for rendering audio content of a media file, the mobile terminal including a vibration device, the arrangement comprising:
a reading unit to read the audio content of the media file;
an identifying unit to identify a signal representing a bass tone within the read audio content of the media file;
a recognition unit to recognize a frequency of the bass tone corresponding to the identified signal;
a checking unit to determine whether the recognized frequency is within an operating frequency range of the vibration device;
a calculating unit to calculate a particular voltage to apply to the vibrator to generate vibrations at the recognized frequency; and
a motor controller to apply the calculated voltage to the vibration device to generate vibrations at the recognized frequency when the identified bass tone of the audio content of the media file is rendered; and
an accelerometer to provide feedback, of a frequency of the generated vibrations, to the calculating unit to permit the calculating unit to adjust the applied voltage to the vibrator to generate vibrations at the recognized frequency when the identified bass tone of the audio content of the media file is rendered.

8. A computer-readable storage medium, for use in rendering audio content of a media file, when executed by a processor in a mobile terminal including a vibration unit to generate vibrations at a particular frequency within an operating frequency range, comprising:
instruction to read the audio content of the media file;
instruction to identify a signal representing a bass tone within the read audio content of the media file;
instruction to recognize a frequency of the bass tone corresponding to the identified signal;
instruction to determine that the recognized frequency is within the operating frequency range of the vibration unit;
instruction to calculate a particular voltage to apply to the vibration unit to generate vibrations at the recognized frequency;
instructions to apply the calculated voltage to the vibration unit to generate vibrations on the recognized frequency when the identified bass tone of the media file is rendered; and
instructions to provide feedback based on a frequency of the generated vibrations to adjust the applied voltage to generate vibrations at the recognized frequency when the identified bass tone of the media file is rendered.
